(19) United States
(12) Patent Application Publication
(10) Pub. No.: US 2005/0144107 A1
(43) Pub. Date: Jun. 30, 2005

(54) Option premium enhanced total returns from a predetermined index or ETF type portfolio

(76) Inventor: Arnold Plonski, Randolph, NJ (US)

Correspondence Address: PITNEY HARDIN LLP, 7 TIMES SQUARE, NEW YORK, NY, 10036-7311, US

(21) Appl. No.: 10/747,754

(22) Filed: Dec. 29, 2003

(51) Int. Cl. G06F 17/60

(52) U.S. Cl. 705/36

(57) ABSTRACT

A portfolio management system is disclosed wherein a portfolio of stocks is purchased, such as a portfolio based on the proportional weighting of stocks in a suitable index or exchange traded fund. For each options cycle, covered calls and cash-secured or margin-secured puts are written for all of the shares of stock in the portfolio. Premiums are collected for the writing of the options. At the end of the options cycle, the “out of the money” options expire without value and the “in the money” options are closed out, using, preferably, a portion of the premiums from the writing of the options, leaving some portion of the premiums to provide an enhancement in the total return from the portfolio. Additionally, a collar and/or a vertical call credit spread combination can be implemented for the portfolio.

### BACKGROUND OF THE INVENTION

1. Field of the Invention

This invention relates to a method of maintaining a predetermined index or exchange traded fund (ETF) type portfolio and writing covered calls and cash-secured or margin-secured puts to enhance the total return from the portfolio. This results in return enhancement while providing risk reduction and downside protection through the use of captured equity option premiums along with the ability to use index collars or index puts to provide insurance type protection for the portfolio.

2. Description of the Prior Art

In the prior art, various active methods of stock portfolio management have been attempted to increase yield from equity instruments while keeping volatility and risk within some desired range. Many of these active methods have not been satisfactory over the long term, due to less than satisfactory attempts at market timing, the high costs and sometimes counterproductive incentives of active management, and the failure of seemingly sophisticated mathematical models to account for transient behavior of the markets, particularly behavior caused by group dynamics. Similarly, the high costs associated with obtaining or deriving market information, either through original analysis or through the purchase of proprietary information, can be prohibitive.

The buying, selling and writing of options can be used to transfer risk and volatility thereby allowing a portfolio manager to increase or decrease risk and volatility. However, such trading in options typically involves some element of market timing and is, therefore, virtually inevitably bound to produce disappointing returns over the long run. On the other hand, it is desirable to be able to capitalize on the option speculators′ trading activity by regularly capturing the time premiums of predetermined portfolios while reducing risk and enhancing total returns.

Options are priced substantially less than the underlying stock. This provides an opportunity for great leverage to the options speculator.

More specifically, “call options” give the buyer of the option (called the holder) the right, but not the obligation, to purchase the underlying stock at a set price, called the strike price, by the expiration date. Call options are typically bought with the expectation of an upward movement in the price of the underlying stock. That is, the holder of the call option expects the stock price to exceed the strike price during the pendency of the call option.

Writing a call option means generating the call option and selling the call option to a holder. This generates a premium (that is, a cash amount paid to the writer as consideration for writing the call option). A “covered call” is when an owner of a security writes a call option on that security. While the ownership of the underlying stock eliminates the theoretically unlimited risk that the writing of a call option entails, the writer of a covered call will not enjoy the benefits of the appreciation of the underlying stock above the strike price during the pendency of the option, as the underlying stock can be “called away” by the holder of the option. However, whether or not the call option is a covered call, if the option expires with the price of the underlying stock below that of the strike price, the option is “out of the money” and expires with no value, allowing the writer to retain the premium with no further obligation.

Similarly, “put options” give the buyer of the option (called the holder) the right, but not the obligation, to sell the underlying stock at a set price, called the strike price, at or before the expiration date. Put options are typically bought with the expectation of a downward movement in the price of the underlying stock. That is, the holder of the put option expects the stock price to be less than the strike price during the pendency of the put option.

Writing a put option means generating the put option and selling the put option to a holder. This generates a premium (that is, a cash amount paid to the writer as consideration for writing the put option). For a cash-secured or margin-secured put option (sometimes called a “covered put”), the writer of the put option keeps a cash amount (or margin availability) on deposit sufficient to cover the purchase of the underlying stock at the strike price. In this way, the writer of the put option will be able to meet the writer's obligations by purchasing the underlying stock at the strike price, if the stock price drops below the strike price, rather than merely closing out the position by paying an amount based on the difference between the stock price and the strike price. This allows the writer of the cash-secured or margin-secured put option to receive a premium while providing an opportunity to buy the underlying stock in the event of a pull-back in the price of the security to below the strike price. Whether or not the put option is cash-secured or margin-secured, if the put option expires with the underlying stock price above the strike price, the option is “out of the money” and expires with no value, allowing the writer to retain the premium with no further obligation.

The potential obligations under both put and call options can be sold by the writer to another person any time prior to the expiration of the applicable option. Additionally, the writer of put or call options can “close out” an option by paying the holder to eliminate the potential obligations of the option. This is frequently done when the value of the option has decreased to a very small value and the chance of the option ever being “in the money” prior to expiration is minimal.

The amount that is paid by the holder to the writer for the option (whether a call option or a put option) is called the option “premium”. The premium consists of two components, the “intrinsic value” and the “time value”. The intrinsic value of a call option is the security price minus the strike price while the intrinsic value of the put option is the strike price minus the security price. The intrinsic value is always a non-negative number, and any calculation of the above which is negative is replaced by zero. The remainder of the option premium is the “time value” which anticipates the possibility of profits in the future by way of favorable price movements in the underlying stock prior to expiration of the option.

In view of the fact that options traders frequently fall into the same “market timing” difficulties and losses as do some ordinary equity traders, it would be advantageous to develop a methodology and systematic approach to capture the “time value” component of the option premium.

Some prior art references relating to options trading or portfolio management include U.S. Pat. No. 6,064,985 entitled “Automated Portfolio Management System with Internet Datafeed” issued on May 16, 2000 to Anderson; U.S. patent application Publication No. 2003/0069821 A1 entitled “Risk Management System for Recommending Options Hedging Strategies”, published on Apr. 10, 2003; and U.S. patent application Publication No. 2002/0174056 A1 entitled “System and Method for Providing User-Specific Options Trading Data”, published on Nov. 21, 2002.

### OBJECTS AND SUMMARY OF THE INVENTION

It is therefore an object of the present invention to provide a system and method for enhancing total return from a portfolio while expecting to lower market risk.

It is therefore a further object of the present invention to provide a system and method for enhancing total return from a portfolio without substantial reliance on market timing.

It is therefore a still further object of the present invention to provide a system and method for enhancing total return from a portfolio, wherein the costs associated with selection of the equities in the portfolio are minimized.

It is therefore a still further object of the present invention to provide a system and method for enhancing total return from a portfolio, wherein the downside risk is reduced.

It is therefore a still further object of the present invention to provide a system and method for enhancing total return from a portfolio, wherein the need for advanced knowledge of the securities industry and access to expensive proprietary information are reduced.

It is therefore a still further object of the present invention to provide a system and method for enhancing total return from a portfolio, wherein the need for access to sophisticated technology is reduced.

It is therefore a still further object of the present invention to provide a system and method for enhancing total return from a portfolio throughout a range of market directions and market conditions.

It is therefore a still further object of the present invention to provide the opportunity to implement a collar or a protective put to protect a portfolio from downside market erosion.

It is therefore a still further object of the present invention to provide the opportunity to systematically capture the time value premiums associated with options on securities in a portfolio in order to enhance total return from the portfolio.

It is therefore a final object of the present invention to provide a system and method for enhancing total return from a portfolio wherein monthly rebalancing or intra-month intervention can be accomplished.

These and other objects can be attained by providing a system and method wherein a securities portfolio is purchased which represents a predetermined index or exchange traded fund (ETF). In predetermined indices or exchange traded funds, the stocks are purchased in accordance with the weighting of that stock within the index or fund. In many cases, the number of shares purchased will differ from stock to stock based upon the weighting in the index or ETF. In the case of the Dow Jones Industrial Average, however, all stocks are weighted equally; therefore, equal numbers of virtually all thirty stocks of the Dow Jones Industrial Average are purchased.

For each option cycle, for each stock in the portfolio, the portfolio manager simultaneously writes cash-secured or margin-secured puts and covered calls at the same (or similar) strike price. Typically, this strike price is chosen to be as close to the market price as possible. At most, only one of the two options will have intrinsic value and both options will have some time value prior to expiration. As the option expiration date approaches, the time value of both options begins to shrink to zero and only one of the options can have intrinsic value. If the market price of the underlying stock is equal to the strike price on an option expiration day, then neither option has intrinsic value and both time premiums have approached zero.

The calls are considered to be “covered” in that the portfolio contains the underlying stocks. Likewise, the puts are considered to be “covered” due to any cash on hand, plus the margin line of credit afforded by the portfolio. At the end of every option month, the “in-the-money” options are closed out and the out-of-the-money options are typically permitted to expire. The put and call options are then rolled or rewritten for the next period or month, and another pair of premiums is collected.

This method is systematically applied to an entire portfolio that represents a pre-determined index or ETF. This increases diversification, reduces volatility and enhances safety of the entire portfolio. By using the component stocks of a predetermined index or ETF, an additional feature of the present invention is the ability to establish a “protective put” to achieve downside protection. To do this with little or no cost, an “out-of-the-money” index option call can be written to collect additional premiums to pay for the index option protective put. This is equivalent to establishing a no-cost (or minimal cost) collar on the entire portfolio. The amount of protection can be matched to the total premium collected for the option cycle month on a percentage basis. The percentage of premium collected relative to the entire portfolio value can be matched to the percent of protection comfort to establish a protective floor, thereby assuring no portfolio exposure below the predetermined level. Additionally, a vertical call credit spread combination can be implemented for the portfolio by purchasing a call option at a higher strike price and selling a call option at a lower strike price, thereby allowing participation in substantial upward market movements.

### BRIEF DESCRIPTION OF THE DRAWINGS

Further objects and advantages of the invention will become apparent from the following description and from the accompanying drawings, wherein:

FIG. 1 is a schematic of the method of the present invention.

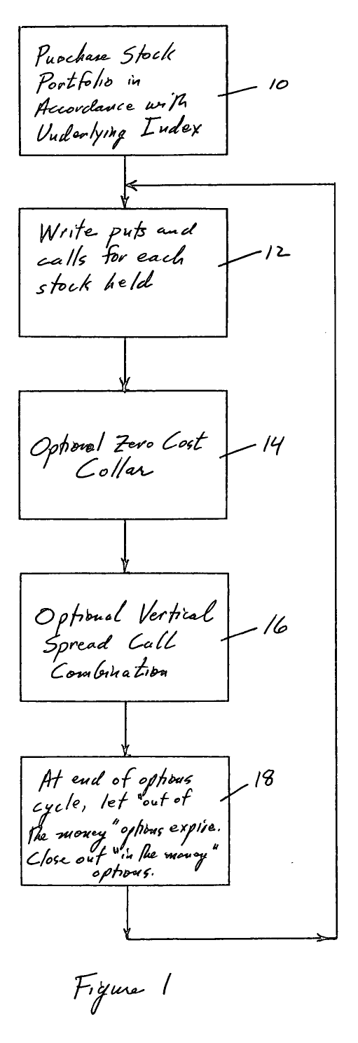

FIG. 2 is a chart of the results of a computer simulation of the present invention, showing the returns for the S & P 500, the Dow Jones Industrial Average, and the present invention using the Dow Jones Industrial Average as the predetermined index for the period from November 2002 to September 2003.

### DETAILED DESCRIPTION OF THE PREFERRED EMBODIMENT

Referring now to the drawings in detail, one sees that the first step in the process is to choose an accepted equity index or EFT from which the stocks are selected for purchase, see step 10. The stocks are purchased in the proportion to which these stocks are weighted within the index or EFT. Examples of suitable equity indices or exchange traded funds are the Dow Jones Industrial Average, the Dow Jones Utilities Average, the Dow Jones Transportation Average, the Dow Jones Composite Average, the S & P 100, the S & P 500, the NASDAQ 100, the Russell 2000, Spiders, DIAMONDs, QUBEs, and any of the myriad of American Exchange Indices (which includes, but is not limited to, an airline index, biotechnology index, broadband hldrs index, computer technology index, defense index, disk drive index, electrical power and natural gas index, gold bugs index, health care sub index, industrial sub index, information technologies sub index, institutional index, internet hldrs index, natural gas index, networking index, oil index, pharmaceutical index, securities broker dealer index, telecom index, tobacco index, wireless hldrs index). Additionally, the index or EFT can be chosen from those in various foreign countries.

Additionally, in some embodiments, it is envisioned that minor deviations can be made from the component stock of an index or EFT. For instance, a low-priced non-volatile persistently sinking public utility stock in the Dow Jones Industrial Average may not be an attractive candidate for option writing, or for that matter, holding in the portfolio, and may be omitted. Similarly, it has been determined that a portfolio with the forty most heavily weighted stocks of the NASDAQ 100 will very closely track the NASDAQ 100. Therefore, those skilled in the art, after review of this disclosure, may substitute those forty most heavily weighted stocks in lieu of the full one hundred stocks of the NASDAQ 100.

Preferably at the beginning of the options cycle, at step 12, puts and calls are written for each and every stock in the portfolio. Preferably, the number of put options written should equal the number of shares (rounded to the nearest hundred) of the given stock held. Likewise, the number of call options written should equal the number of shares (rounded to the nearest hundred) of the given stock held. For each security, the puts and calls are written at equal (or similar) strike prices and expiration dates. Typically, the strike price chosen is the closest strike price to the market price of the stock. Typically, the strike prices at which options can be written have intervals of five dollars. However, it is not uncommon for the strike prices to have intervals of two dollars and fifty cents. The expiration dates are typically chosen to be roughly monthly. However, other expiration dates may be chosen.

A less aggressive (or more conservative) variation is to write the calls at a higher strike price than the strike price at which the puts are written. The strike price of the call may be chosen to be somewhat above the market price and the strike price of the put may be chosen to be somewhat below the market. Therefore, both options are “out-of-the-money” when written and if subsequent market changes are minimal, both options may stay “out-of-the-money” and both premiums may be retained without any obligation at expiration. The trade-off, of course, is that the premiums for options which are “out-of-the-money” at the time of writing are less, all other things being equal, than the premiums for options which are “in-the-money” at the time of writing.

A more aggressive approach is to write the calls at a lower strike price than the strike price at which the puts are written. The strike price of the call may be chosen to be somewhat below the market price and the strike price of the put may be chosen to be somewhat above the market price. Therefore, both options are “in-the-money” when written and at least one option can be expected to remain “in-the-money” at expiration. If the market price at expiration stays between the two strike prices, then the total of the amount that the two options are “in-the-money” is equal to the difference between the strike prices. However, if the market price is less than the lower strike price (at which the call is written) or greater than the higher strike price (at which the put is written), then one option will be “in-the-money” for an amount greater than the difference between the strike prices. This more aggressive approach results in higher premiums being received for the initial writing of the options, but likewise risks greater losses from the options, particularly during substantial upward or downward market movements.

The calls which are written are considered to be “covered calls” (as opposed to “naked calls”) in that the writer of the calls already owns the underlying stocks. Similarly, the puts which are written are considered to be “covered puts” in that the underlying stocks provide adequate margin availability for this purpose. Additionally, the portfolio may hold some amount of cash on hand, particularly from the premiums collected for writing the options and any stock dividends paid.

The writing of the options, of course, generates premiums which are deposited within the portfolio. These premiums, along with the dividends and any other income received, are used to close out option positions, as necessary (as described hereinafter). The amount of cash left after closing out the option positions provides for an enhancement of the total return from the portfolio.

Optionally, at step 14, a collar can be implemented to protect against down-side loss. To do this with little or no cost, an “out-of-the-money” representative index option call can be written to collect additional premiums to pay for the index option protective put. This is substantially equivalent to establishing a zero-cost collar or minimal cost collar on the entire portfolio.

Similarly, optionally, at step 16, a vertical call credit spread combination is implemented for the underlying stock or for the applicable index or EFT. That is, a first call option is written and a second call option is purchased. The second call option is purchased for the same underlying stock (or index or EFT) and expiration date as the first call option. However, the strike price of the second call option is higher than the strike price of the first call option. This is a bullish position in that the holder of the covered vertical call credit spread combination participates in sharp upward rises in the market. That is, the vertical call credit spread combination will effect a loss to the extent that the market price exceeds the strike price of the first (written) option, but the total loss is limited by the difference between the two strike prices (as adjusted by the premium differential) because any incremental increase in market price above the second strike price causes an increase in value of the second (purchased) option which offsets the increase in any loss resulting from the first (written) option. However, as this combination is “covered” by the securities owned in the portfolio, there is a net gain if the substantial market increase exceeds the difference between the two strike prices (as adjusted by the premium differential). The two strike prices and expiration dates are chosen by methods as would be known to one skilled in the art, particularly in view of what market upswing is expected and what risks are considered acceptable.

As shown at step 18, when the option period expires, any “out-of-the-money” options are permitted to expire and “in-the-money” options are closed out. The closing out of the “in-the-money” options is envisioned to require less money, on average, than was collected as the premiums for writing the options in the first place. In this way, the total return from the portfolio is enhanced.

After the options have either expired or been closed out, as shown at step 16, the process returns to step 12 wherein a new set of covered calls and covered puts are written and premiums collected. As the strike prices of the new set of covered options are intended to follow the market, the method becomes self-adjusting with respect to market prices thereby eliminating any market timing component to the method.

This method results in incremental gains from the systematic capture of the option premiums.

As this method requires little human decision making after the method has been started, this method is particularly well adapted to be automated through program trading or similar computer-based trading systems, particularly the writing of options at the beginning of the options cycle and the closing out of “in-the-money” options at the end of the options cycle.

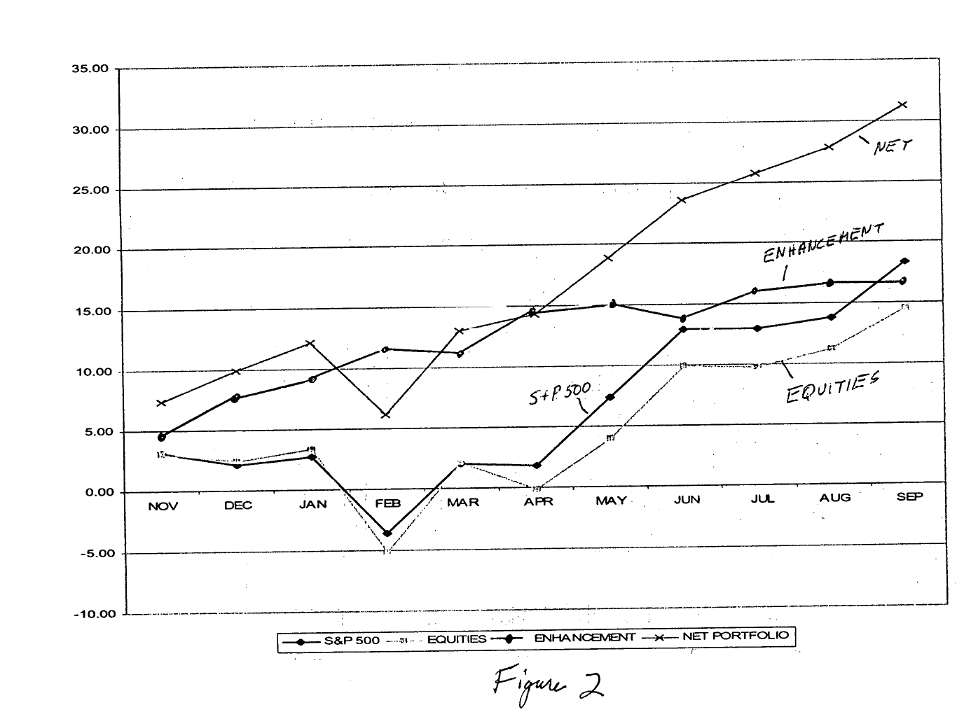

As can be seen in FIG. 2, a computer model has simulated or tracked the returns which would have been achieved by the invention of the present method using the stocks in the Dow Jones Industrial Average (presently 30 stocks, as is known by those skilled in the art) as the portfolio, for November 2002 through September 2003. The returns for the Dow Jones Industrial Average and the S & P 500 (without the use of the present method) are shown. Additionally, the total return for the present method (using a portfolio consisting of the stocks in the Dow Jones Industrial Average) is shown and it clearly exceeds the return from the Dow Jones Industrial Average.

Thus the several aforementioned objects and advantages are most effectively attained. Although a single preferred embodiment of the invention has been disclosed and described in detail herein, it should be understood that this invention is in no sense limited thereby and its scope is to be determined by that of the appended claims.

1. A method for portfolio management comprising the steps of:
purchasing shares of a plurality of stocks thereby providing a portfolio, said plurality of stocks being the stocks represented in an index or exchange traded fund, said shares being purchased in proportion to the weighting of the respective stocks in said index or exchange traded fund;
at the beginning of substantially each options cycle, writing a number of call options and a number of put options for each of said plurality of stocks; and
at the end of substantially each options cycle, letting the out-of-the-money options expire and closing out the in-the-money options.

2. The method for portfolio management of claim 1 wherein, for each of said plurality of stocks, said number of call options and said number of put options is substantially equal to the number of shares of stock purchased.

3. The method for portfolio management of claim 1 wherein, for each of said plurality of stocks, a strike price for the call options is equal or substantially equal to a strike price for the put options.

4. The method of portfolio management of claim 1 wherein, for each of said plurality of stocks, said strike prices of said put and call options are chosen to be as close as possible to the market price of the stock at the time of writing.

5. The method of portfolio management of claim 1 wherein, for each of said plurality of stocks, a strike price for said number of call options is above the market price of the respective stock at the time of writing, and a strike price for said number of put options is below the market price of the respective stock at the time of writing.

6. The method of portfolio management of claim 1 wherein, for each of said plurality of stocks, a strike price for said number of call options is below the market price of the respective stock at the time of writing, and a strike price for said number of put options is above the market price of the respective stock at the time of writing.

7. The method for portfolio management of claim 2 wherein, for each of said plurality of stocks, an expiration date for said call options is equal to an expiration date for said put options.

8. The method for portfolio management of claim 1 further including the step of implementing a collar for said portfolio to reduce or minimize losses during market declines.

9. The method for portfolio management of claim 8 wherein said step of implementing a collar further includes the step of writing an index option call and purchasing an index option protective put.

10. The method for portfolio management of claim 9 wherein a premium received for said step of writing said index option call is substantially equal to a premium spent for said step of purchasing an index option protective put.

11. The method for portfolio management of claim 1 further including a step of implementing a vertical call credit spread combination for said portfolio.

12. The method for portfolio management of claim 11 wherein said step of purchasing a vertical call credit spread combination comprises writing a first call option at a first strike price and purchasing a second call option at a second strike price, wherein said second strike price is greater than said first strike price.

13. The method for portfolio management of claim 1 wherein said index is the Dow Jones Industrial Average.

14. The method for portfolio management of claim 1 wherein said index is the Standard and Poors 100, or a substantial portion thereof reflecting the S & P 100.

15. The method for portfolio management of claim 1 wherein said index is the NASDAQ 100, or a substantial portion thereof reflecting the NASDAQ 100.

16. The method for portfolio management of claim 1 wherein said exchange traded fund is chosen from the group consisting of Spiders, DIAMONDs and QUBEs.

17. The method for portfolio management of claim 1 wherein said index is chosen from the group consisting of the American Exchange Indices.

18. The method for portfolio management of claim 1 wherein said index is chosen from the group consisting of any other index, exchange traded fund or suitable portfolio grouping that trades options.

19. The method for portfolio management of claim 1 wherein premiums received for writing a number of call options and a number of put options are retained in the portfolio, and some portion of said premiums are used in said step of closing out the in-the-money options.

20. The method for portfolio management of claim 1 wherein in said step of writing a number of call options and a number of put options, said call options are covered and said put options are covered.

21. The method of claim 1 wherein said steps of writing a number of call options and a number of put options and closing out the in-the-money options is performed using computer automation.

22. A method for portfolio management comprising the steps of:
purchasing shares of a plurality of stocks thereby providing a portfolio, said plurality of stocks being selected from at least a substantial portion of an index or exchange traded fund and being purchased in proportions to be representative of the respective stocks in said index or exchange traded fund;
by the beginning of substantially each options cycle, writing a number of call options and a number of put options for each of said plurality of stocks; and
at the end of substantially each options cycle, letting the out-of-the-money options expire and closing out the in-the-money options.

23. A method for portfolio management comprising the steps of:
purchasing shares of a selection of stocks within a group or industry thereby providing a portfolio;
at the beginning of substantially each options cycle, writing a number of call options and a number of put options for each of said selection of stocks; and
by the end of substantially each options cycle, letting the out-of-the-money options expire and closing out the in-the-money options.

24. A method for portfolio management comprising the steps of:
purchasing shares of a plurality of stocks thereby providing a portfolio;
at the beginning of substantially each options cycle, writing a number of call options and a number of put options for each of said plurality of stocks; and
by the end of substantially each options cycle, letting the out-of-the-money options expire and closing out the in-the-money options.
